(19) United States
(12) Patent Application Publication
(10) Pub. No.: US 2025/0123096 A1
(43) Pub. Date: Apr. 17, 2025

(54) MULTI-THICKNESS OVERLAY MEASUREMENT SYSTEM

(71) Applicant: KLA Corporation, Milpitas, CA (US)

(72) Inventors: Amiram Hazzot, Moledet (IL); Yakir Biton, Achuzat Barak (IL); Michael Har-Zvi, Tel-Aviv (IL); Hen Gruman, Rakafet (IL); Asaf Wiseman, Kibbutz Hanita (IL); Dror Rosenthal, Kiryat Tivon (IL)

(21) Appl. No.: 18/736,137

(22) Filed: Jun. 6, 2024

Related U.S. Application Data
(60) Provisional application No. 63/544,233, filed on Oct. 16, 2023.

(51) Int. Cl. G01B 11/06; G01B 11/24; G01B 11/27

(52) U.S. Cl. CPC G01B 11/06; G01B 11/24; G01B 11/27

(57) ABSTRACT

A measurement system is disclosed. The measurement system may include a controller including processors configured to execute program instructions causing the processors to: receive recipes including instructions for characterizing the set of samples with an optical sub-system, wherein the recipes include thicknesses for the set of samples; receive on-tool thickness measurements for the set of samples from the sample measurement sub-system; validate the thicknesses of the set of samples provided by the recipes with the on-tool thickness measurements generated by a sample measurement sub-system configured to measure a thickness of at least one sample from the set of samples prior to characterization by the optical sub-system; provide the focus adjustment system with sample-specific hard stop positions based on the validated thicknesses of the set of samples; and generate one or more measurements of the set of samples based on measurement data from the optical sub-system.

### CROSS REFERENCE TO RELATED APPLICATIONS

The present application claims the benefit under 35 U.S.C. § 119 (e) of U.S. Provisional Application No. 63/544,233, filed Oct. 16, 2023, which is incorporated herein by reference in the entirety.

### FIELD

The present disclosure relates to measurement systems, and more particularly, to measurement systems configured to provide for measurement of varying thickness objects.

### BACKGROUND

Many measurement systems do not account for the possibility that wafers of different thickness may be measured by the same system, which may lead to damage to the system and/or the wafers if they come into contact. This may also lead to issues with alignment and/or focus of the wafers within the measurement system. To convert a system manually from one thickness measurement to another may take hours each time a different thickness needs to be measured. Current systems that correct for varying thicknesses require updates and/or changes to software and/or hardware, which may be costly and time consuming. Therefore, it may be desirable to create a system curing the above deficiencies.

### SUMMARY

A measurement system is disclosed, in accordance with one or more embodiments of the present disclosure. In embodiments, the measurement system includes a controller including one or more processors configured to execute program instructions. In embodiments, the one or more processors are configured to receive one or more recipes including instructions for characterizing the set of samples with an optical sub-system, wherein the one or more recipes include thicknesses for the set of samples. In embodiments, the optical sub-system includes an objective lens. In embodiments, the optical sub-system includes one or more detectors configured to generate measurement data based on light from a test sample collected by the objective lens. In embodiments, the optical sub-system includes a focus adjustment system including one or more translation stages configured to control a separation distance between the objective lens and the test sample. In embodiments, the one or more processors are configured to receive on-tool thickness measurements for the set of samples from a sample measurement sub-system configured to measure a thickness of at least one sample from the set of samples prior to characterization by the optical sub-system, wherein the at least one sample is from a sample measurement sub-system couple to the optical sub-system. In embodiments, the one or more processors are configured to validate the thicknesses of the set of samples provided by the one or more recipes with the on-tool thickness measurements generated by a sample measurement sub-system. In embodiments, the one or more processors are configured to provide the focus adjustment system with sample-specific hard stop positions based on the validated thicknesses of the set of samples. In embodiments, the one or more processors are configured to generate one or more measurements of the set of samples based on measurement data from the optical sub-system.

A measurement system is disclosed, in accordance with one or more embodiments of the present disclosure. In embodiments, the measurement system includes an optical sub-system. In embodiments, the optical sub-system includes an objective lens. In embodiments, the optical sub-system includes one or more detectors configured to generate measurement data based on light from a test sample collected by the objective lens. In embodiments, the optical sub-system includes a focus adjustment system including one or more translation stages configured to control a separation distance between the objective lens and the test sample. In embodiments, the measurement system includes a sample management sub-system configured to receive a set of samples for measurement by the optical sub-system. In embodiments, the measurement system includes a sample measurement sub-system configured to measure a thickness of at least one sample from the set of samples prior to characterization by the optical sub-system. In embodiments, the measurement system includes a controller including one or more processors configured to execute program instructions. In embodiments, the one or more processors are configured to receive on-tool thickness measurements for the set of samples from a sample measurement sub-system. In embodiments, the one or more processors are configured to validate the thicknesses of the set of samples provided by the one or more recipes with the on-tool thickness measurements generated by a sample measurement sub-system configured to measure a thickness of at least one sample from the set of samples prior to characterization by the optical sub-system. In embodiments, the one or more processors are configured to provide the focus adjustment system with sample-specific hard stop positions based on the validated thicknesses of the set of samples. In embodiments, the one or more processors are configured to generate one or more measurements of the set of samples based on measurement data from the optical sub-system.

A method is disclosed, in accordance with one or more embodiments of the present disclosure. In embodiments, the method includes receiving one or more recipes including instructions for characterizing the set of samples with an optical sub-system, wherein the one or more recipes include thicknesses for the set of samples, wherein the optical sub-system comprises: an objective lens; one or more detectors configured to generate measurement data based on light from a test sample collected by the objective lens; and a focus adjustment system including one or more translation stages configured to control a separation distance between the objective lens and the test sample. In embodiments, the method includes receiving on-tool thickness measurements for the set of samples from a sample measurement sub-system. In embodiments, the method includes validating the thicknesses of the set of samples provided by the one or more recipes with the on-tool thickness measurements generated by a sample measurement sub-system configured to measure a thickness of at least one sample from the set of samples prior to characterization by the optical sub-system. In embodiments, the method includes providing the focus adjustment system with sample-specific hard stop positions based on the validated thicknesses of the set of samples. In embodiments, the method includes generating one or more measurements of the set of samples based on measurement data from the optical sub-system.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 is a block diagram illustrating a measurement system, in accordance with one or more embodiments of the present disclosure.

FIG. 2 is a schematic of a process for sample measurement, in accordance with one or more embodiments of the present disclosure.

FIG. 3A is a flow diagram illustrating a method for overlay measurement, in accordance with one or more embodiments of the present disclosure.

FIG. 3B is a flow diagram illustrating a method for overlay measurement, in accordance with one or more embodiments of the present disclosure.

FIG. 3C is a flow diagram illustrating steps of a method for overlay measurement, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

A measurement system capable of measuring samples of varying thicknesses is disclosed, in accordance with one or more embodiments of the present disclosure. Samples may be measured, and those measurements may be compared to user-defined measurements. If the measurements match, the samples may enter an optical sub-system for characterization. The optical sub-system may perform various measurements on the samples to determine sample characteristics. Further, based on the thickness of each sample, software may automatically adjust a hard stop between the sample and a component of the optical sub-system for each sample. This may be done to prevent contact between the sample and the optical sub-system and to preserve focus of the sample.

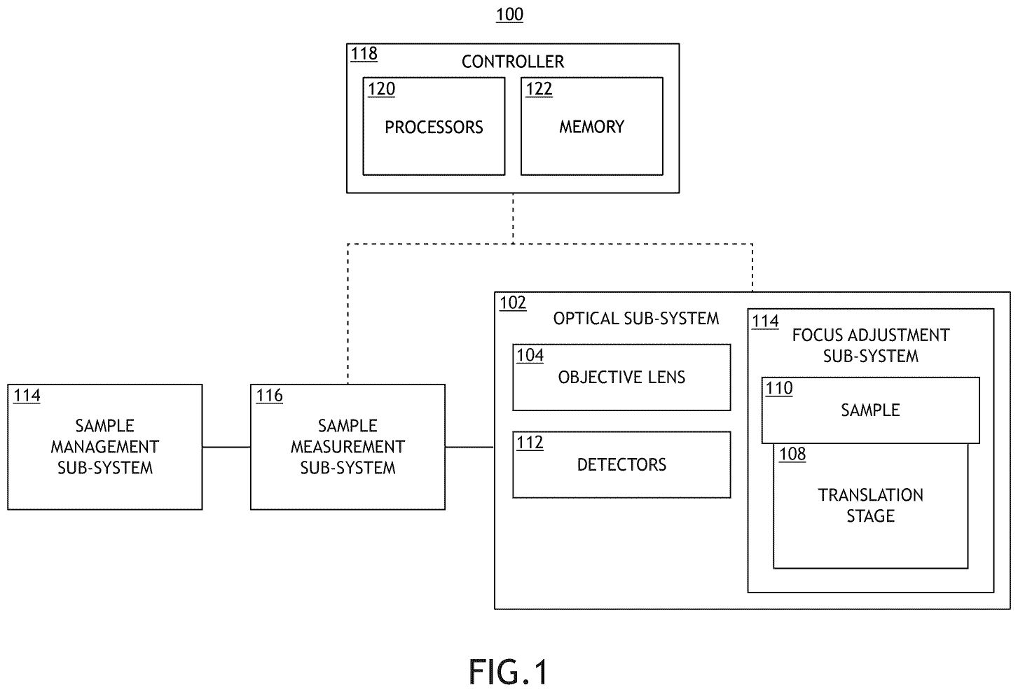

FIG. 1 is a block diagram illustrating a measurement system 100, in accordance with one or more embodiments of the present disclosure.

In embodiments, the measurement system 100 may include an optical sub-system 102. The optical sub-system 102 may either be a metrology system or an inspection system. Further, the optical sub-system 102 may be an image-based metrology sub-system (e.g., an imaging system) (e.g., the detector 112 is at a field plane conjugate to the sample 110) or a pupil-plane system (e.g., the detector 112 is at a pupil plane to view an angular distribution of light from the sample 110). For example, the optical sub-system 102 may direct illumination to a sample 110 and may further collect light or other radiation emanating from the sample 110 to generate an overlay signal suitable for the determination of overlay of two or more sample layers. As a nonlimiting example, the optical sub-system 102 may be any type of overlay metrology tool known in the art suitable for generating overlay signals suitable for determining overlay associated with overlay targets on a sample 110. As another nonlimiting example, the optical sub-system may be any metrology system known in the art. As another nonlimiting example, the optical sub-system 102 may be an inspection system. The optical sub-system 102 may selectively operate in an imaging mode or a non-imaging mode. For example, in an imaging mode, individual overlay target elements may be resolvable within the illuminated spot on the sample 110 (e.g., as part of a bright-field image, a dark-field image, or the like). By way of another example, the optical sub-system 102 may operate as a scatterometry-based overlay metrology tool in which radiation from the sample 110 is analyzed at a pupil plane to characterize the angular distribution of radiation from the sample 110 (e.g., associated with scattering and/or diffraction of radiation by the sample 110).

In embodiments, the optical sub-system 102 may include an objective lens 104.

In embodiments, the optical sub-system 102 may include a focus adjustment system 106. The focus adjustment system 106 may include a one or more translation stages 108. The one or more translation stages 108 may include any number of actuators (e.g., linear, rotational, and/or angular tip/tilt actuators). The one or more translation stages 108 may be configured to control a separation distance between the objective lens 104 and a sample 110 (e.g., a test sample 110 from a set of samples 110). It should be noted that all of the samples 110 in the set of samples 110 may have a common thickness. However, that is not necessary, and the thickness of samples 110 in the set of samples 110 may differ (e.g., at least one sample 110 in the set of samples 110 may have a thickness different than at least one additional sample in the set of samples 110).

In embodiments, the optical sub-system 102 includes one or more detectors 112. For example, the one or more detectors 112 may be configured to generate measurement data based on light collected from a sample 110 (e.g., light reflected by a test sample) by the objective lens 104. By way of another example, the one or more detectors 112 may be configured to generate metrology data or inspection data based on light collected from a sample 110 by the objective lens 104. Measurement data may include data such as, but not limited to metrology data (e.g., overlay, critical dimension (CD), film thickness, or the like) or inspection data (e.g., identify one or more defects on the set of samples based on inspection data, characterize one or more defects on the set of samples based on inspection data, or the like).

In embodiments, the measurement system 100 includes a sample management sub-system 114. The sample management sub-system 114 may be configured to receive a set of samples 110. The set of samples 110 may then be measured by the optical sub-system 102. As an example, the sample management sub-system 114 may be configured as a front opening unified pod (FOUP). The sample management sub-system 114 may hold any number of samples 110 (e.g., wafers). For example, the sample management sub-system 114 may hold 25 samples 110.

In embodiments, the measurement system 100 includes a sample measurement sub-system 116. The sample management sub-system 116 may measure samples 110 (e.g., wafer thickness) with any technique known in the art such as, but not limited to, capacitive sensors or interferometry. The sample measurement sub-system 116 may be configured to measure a thickness of at least one sample 110 from the set of samples 110. The sample measurement sub-system 116 may measure the thickness of the at least one sample from the set of samples 110 before they are characterized by the optical sub-system 102. The sample measurement sub-system 116 may be configured to take multiple thickness measurements (e.g., the on-tool thickness measurements include multiple thickness measurements for at least one sample 110 of the set of samples 110). The optical sub-system 102 may generate one or more measurements per sample 110. For example, multiple measurements may be used to generate a thickness map of the sample 110, which may be suitable for, but not limited to, generating bow data for the sample 110.

In embodiments, the system 100 includes a controller 118. The controller may include one or more processors 120 and a memory 122.

The one or more processors 120 of the controller 118 may be communicatively coupled to memory 122, wherein the one or more processors 120 may be configured to execute a set of program instructions maintained in memory 122, and the set of program instructions may be configured to cause the one or more processors 120 to carry out various functions and steps of the present disclosure.

It is noted herein that the one or more components of screening system 100 may be communicatively coupled to the various other components of screening system 100 in any manner known in the art. For example, the one or more processors 120 may be communicatively coupled to each other and other components via a wireline (e.g., copper wire, fiber optic cable, and the like) or wireless connection (e.g., RF coupling, IR coupling, WiMax, Bluetooth, 3G, 4G, 4G LTE, 5G, and the like). By way of another example, the controller 118 may be communicatively coupled to one or more components of screening system 100 via any wireline or wireless connection known in the art.

In embodiments, the one or more processors 120 may include any one or more processing elements known in the art. In this sense, the one or more processors 120 may include any microprocessor-type device configured to execute software algorithms and/or instructions. In one embodiment, the one or more processors 120 may consist of a desktop computer, mainframe computer system, workstation, image computer, parallel processor, or other computer system (e.g., networked computer) configured to execute a program configured to operate the screening system 100, as described throughout the present disclosure. It should be recognized that the steps described throughout the present disclosure may be carried out by a single computer system or, alternatively, multiple computer systems. Furthermore, it should be recognized that the steps described throughout the present disclosure may be carried out on any one or more of the one or more processors 120. In general, the term “processor” may be broadly defined to encompass any device having one or more processing elements, which execute program instructions from memory 122. Moreover, different sub-systems of the measurement system 100 (e.g., optical sub-system 102, sample management sub-system 114, sample measurement sub-system 116, controller 118, and the like) may include processor or logic elements suitable for carrying out at least a portion of the steps described throughout the present disclosure. Therefore, the above description should not be interpreted as a limitation on the present disclosure but merely an illustration.

The memory 122 may include any storage medium known in the art suitable for storing program instructions executable by the associated one or more processors 120 and the data received from the screening system 100. For example, the memory 122 may include a non-transitory memory medium. For instance, the memory 122 may include, but is not limited to, a read-only memory (ROM), a random-access memory (RAM), a magnetic or optical memory device (e.g., disk), a magnetic tape, a solid-state drive and the like. It is further noted that memory 122 may be housed in a common controller housing with the one or more processors 120. In an alternative embodiment, the memory 122 may be located remotely with respect to the physical location of the processors 120, controller 118, and the like. In another embodiment, the memory 122 maintains program instructions for causing the one or more processors 120 to carry out the various steps described through the present disclosure.

The one or more processors 120 may receive one or more recipes (e.g., metrology recipes). The recipes may include instructions for characterizing the set of samples 110 with the optical sub-system 102 based on various parameters. As a nonlimiting example, the one or more recipes may include instructions for characterizing the set of samples 110 based on the thickness of the set of samples 110.

The one or more processors 120 may receive one or more on-tool thickness measurements from the sample measurement sub-system 116. For example, the on-tool thickness measurements may correspond to a thickness of at least one sample 110 from the set of samples 110 before the set of samples 110 is characterized by the optical sub-system 102. By way of another example, all samples 110 in the set of samples 110 may be measured individually. An on-tool thickness measurement may be a thickness measurement made by a measurement device (e.g., a tool) that is located between the sample management sub-system 114 (e.g., the FOUP) and the optical sub-system 102.

The one or more processors 120 may use the on-tool thickness measurements from the sample measurement sub-system 116 to validate the thicknesses of the set of samples 110 that is provided in the metrology recipes. For example, the metrology recipe may correspond to thicknesses provided by a user. By way of another example, thickness may also be provided by other tools, databases, or the like. The measurement process may be stopped if the metrology recipe does not match with the on-tool thickness measurements.

The validated thicknesses of the set of samples 110 may be used to provide the focus adjustment system 106 with sample-specific hard stop positions. For example, the sample-specific hard stop positions may be configured so that there is a minimum distance between the sample 110 and the objective lens 104. The hard stop may be dynamically adjustable (e.g., the hard stop changes based on the thickness of a sample 110). This may be done for each sample 110 in the set of samples 110. For example, the one or more translation stages 108 may be moved to a different hard stop position for each sample 110 in order to provide a desired level of focus for each sample thickness. Additionally, there may be one or more safety mechanisms included in the optical sub-system 102 to prevent the one or more translation stages 108 from bringing the sample 110 into contact with the optical sub-system 102 and crushing the sample 110 based on the sample-specific hard stops.

It is noted that the distance between the sample 110 and the objective lens 104 may be any value. For example, the distance between the sample 110 and the objective lens 104 may be between 250 and 280 micrometers (e.g., a focus length). However, the focus length may be as little as 100 micrometers.

The one or more processors 120 may generate one or more measurements (e.g., thickness measurements) for each sample in the set of samples 110. The one or more processors 120 may generate the measurements based on data collected by the optical sub-system 102. For example, the thickness measurements do not match the on-tool thickness measurement generated by the sample measurement sub-system 116 (e.g., the two measurements differ), the processors may be configured to generate an alert (e.g., an audio or visual alert). By way of another example, if the thickness measurements do not match the on-tool measurement generate by the sample measurement sub-system 116 a measurement may not be generated.

The one or more processors 120 may generate a score for each sample 110 in the set of samples 110. The score may be based on one or more sample characteristics. The one or more sample characteristics may include but are not limited to the corresponding on-tool thickness measurement, wobble measurements, thickness measurements, bow measurements (e.g., wafer bow data), and other physical parameters.

Based on the wafer bow data (e.g., when the on-tool thickness measurements include multiple thickness measurements for a given sample 110), the one or more processors 120 may generate site-specific hard stop positions based on the wafer bow data (e.g., there are different hard stop positions for different locations on a sample 110).

The one or more processors 120 may further direct the optical sub-system 102 to generate data for one or more samples 110 in the set of samples 110 if the sample 110 satisfies a selected threshold. The processors 120 may cause the optical sub-system 102 to exclude any sample 110 in the set of samples 110 that does not meet the selected threshold.

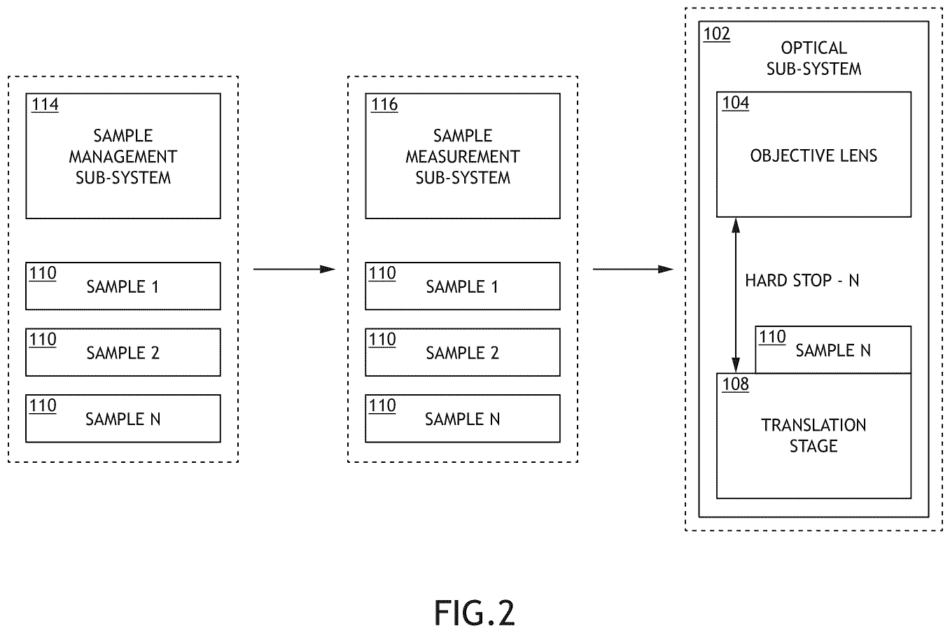

FIG. 2 is a schematic of a process for sample measurement, in accordance with one or more embodiments of the present disclosure.

In embodiments, a set of samples 110 may be placed on a sample management sub-system 114. For example, the sample management sub-system 114 may be a FOUP. The sample management sub-system 114 may hold any number of samples 110 (e.g., sample 1 through sample N). In this way, the set of samples 110 includes N samples 110.

The set of samples 110 may then be introduced to a sample measurement sub-system 116. The sample measurement sub-system 116 may be configured to take a set of on-tool thickness measurements of each sample 110 in the set of samples 110. Each sample 110 may have one or more on-tool thickness measurements taken of it. These on-tool thickness measurements may be compared with measurements provided by a user. This will allow the thickness of the sample 110 to be validated and tell the user if there is a sample 110 with a different thickness. The on-tool thickness measurements may be used to generate a hard stop for each sample 110.

It should be noted that the sample measurement sub-system 116 may be physically near or integrated with the sample management sub-system 114 and/or a housing of the optical sub-system 102 (e.g., the measurement system 100 is an on-tool system suitable for checking sample thickness directly before a measurement.

The set of samples 110 may then be introduced to an optical sub-system 102. The optical sub-system 102 may be configured to take various measurements of each sample 110 within the set of samples 110. The hard stop may be used to provide a distance between the sample 110 (or the one or more translation stages 108) and the objective lens 104. This may prevent the sample 110 from making contact with the objective lens 104 and being damaged. Further, each sample 110, or various locations on each sample 110 may have corresponding hard stops. For example, sample 1 may have a different hard stop than sample N. By way of another example, multiple measurements may be taken for each sample 110, where the multiple measurements correspond to site-specific hard stop positions.

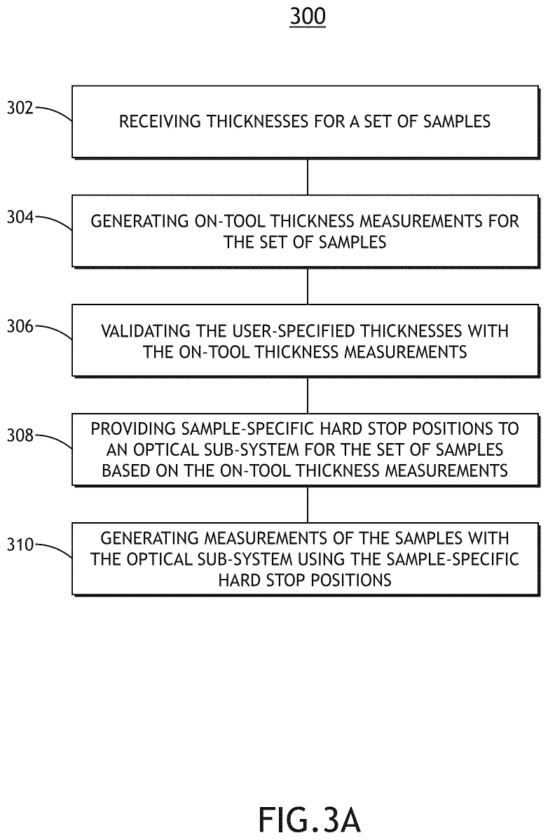

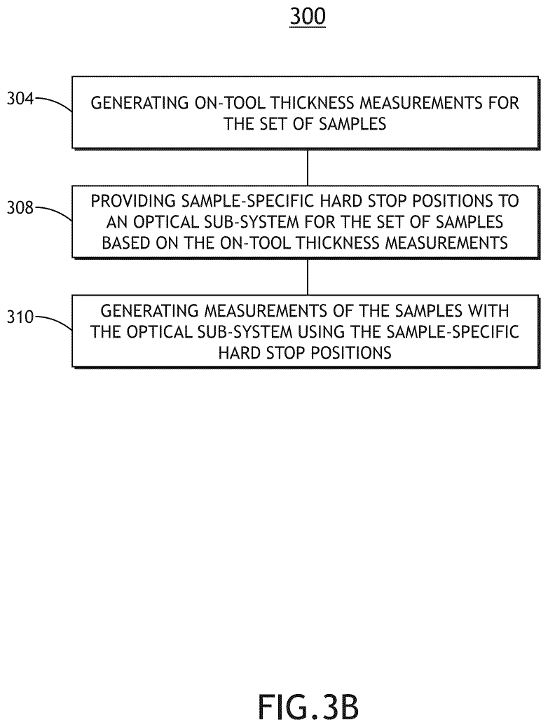

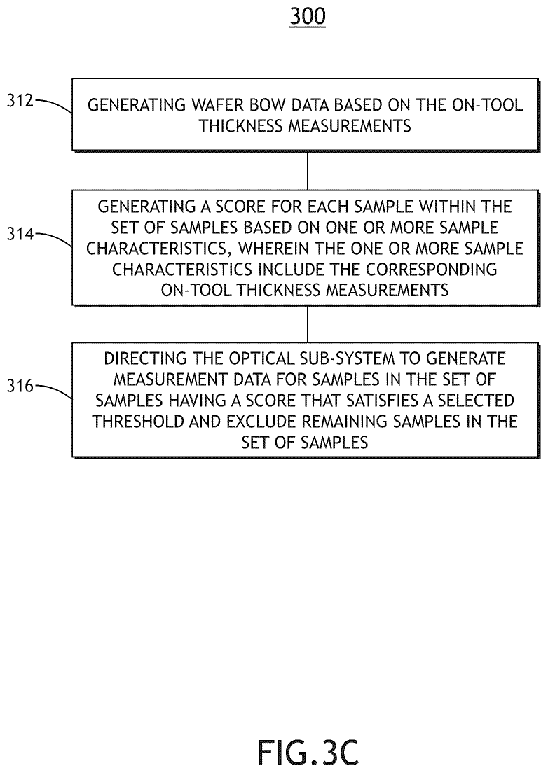

FIGS. 3A and 3B are flow diagrams illustrating a method 300 for overlay measurement, in accordance with one or more embodiments of the present disclosure. Applicant notes that the embodiments and enabling technologies described previously herein in the context of the measurement system 100 should be interpreted to extend to the method 300. It is further noted, however, that the method 300 is not limited to the architecture of the measurement system 100.

In embodiments, the method 300 includes a step 302 of receiving thicknesses for a set of samples 110. The thickness may come from any source including, but not limited to users (e.g., a user-specified thickness). For example, the user-specified thicknesses may be provided by or included within a metrology recipe (e.g., a recipe including at least thickness of a sample). The set of samples 110 may be characterized by an optical sub-system.

In embodiments, the method 300 includes a step 304 of generating on-tool thickness measurements for the set of samples 110. For example, the on-tool thickness measurements may be generated using a sample measurement sub-system.

In embodiments, the method 300 includes a step 306 of validating the thickness with the on-tool thickness measurements. For example, the recipes may contain for each sample of the set of samples 110. The recipe may be compared with the on-tool thickness measurements generated by the sample measurement sub-system to validate that the two measurements are the same. This may be done prior to the samples 110 being characterized by the optical sub-system.

In embodiments, the method 300 includes a step 308 of providing sample-specific hard stop positions to an optical sub-system for the set of samples 110 based on the on-tool thickness measurements. For example, each sample in the set of samples 110 may have a different hard stop position (e.g., based on the sample thickness). This may permit samples 110 in the set of samples 110 to be of a varying thickness.

In embodiments, the method 300 includes a step 310 of generating one or more measurements of the samples 110 with the optical sub-system using the sample-specific hard stop positions. The sample-specific hard stop positions may prevent the sample from contact an objective lens. Further, the one or measurements generated may be based on measurement data from the optical sub-system.

It should be noted, as illustrated in FIGS. 3A and 3B that the method 300 may be formed from various permutations of steps and processes. For example, the method 300 may include steps 302-310 (e.g., as illustrated in FIG. 3A). By way of another example, the method 300 may include only some steps (e.g., step 304, step 308, and step 310 (e.g., as illustrated in FIG. 3B)).

FIG. 3C is a flow diagram illustrating additional steps 312, 314, 316 in a method 300, in accordance with one or more embodiments of the present disclosure. It should be noted that the steps 312, 314, 316 illustrated in FIG. 3C may be performed alone, or may be performed in conjunction with any other step or process described in the present disclosure. For example, step 314 may be paired with step 316, but operate without steps 302-210. By way of another example, step 312 may be performed without any other steps or processes described in the present disclosure.

In embodiments, the method 300 includes a step 312 of generating wafer bow data based on the on-tool thickness measurements. For example, each sample of the set of samples 110 may have one or more on-tool thickness measurements generated. This may allow wafer bow data to be generated for each sample based on the multiple on-tool thickness measurements for each sample. The wafer bow data may be used to generate site-specific hard stops (e.g., different locations on each sample have different hard stops corresponding to the wafer bow data).

In embodiments, the method 300 includes a step 314 of generating a score for each sample within the set of samples 110 based on one or more sample characteristics, wherein the one or more sample characteristics include the corresponding on-tool thickness measurements. The sample characteristics may include, but are not limited to thickness measurements, wafer bow data, wobble measurements, or other physical parameters.

In embodiments, the method 300 includes a step 316 of directing the optical sub-system to generate measurement data for samples in the set of samples having a score that satisfies a selected threshold and exclude remaining samples in the set of samples.

It should be noted that the steps and processes disclosed herein of on-tool thickness measurement and generation of a sample-specific (or site-specific) hard stops (with or without validation of supplied thicknesses) can be done without impacting measurement throughput as a whole. For example, thickness measurement may be done by a tool handler prior to loading a set of samples onto the tool, (e.g., while the tool is measuring another sample).

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A measurement system comprising:
a controller including one or more processors configured to execute program instructions causing the one or more processors to:
receive one or more recipes including instructions for characterizing a set of samples with an optical sub-system, wherein the one or more recipes include thicknesses for the set of samples, wherein the optical sub-system comprises:
an objective lens;
one or more detectors configured to generate measurement data based on light from a test sample collected by the objective lens; and
a focus adjustment system including one or more translation stages configured to control a separation distance between the objective lens and the test sample;
receive on-tool thickness measurements for the set of samples from a sample measurement sub-system configured to measure a thickness of at least one sample from the set of samples prior to characterization by the optical sub-system, wherein the at least one sample is from a sample measurement sub-system coupled to the optical sub-system;
validate the thicknesses of the set of samples provided by the one or more recipes with the on-tool thickness measurements generated by the sample measurement sub-system;
provide the focus adjustment system with sample-specific hard stop positions based on the validated thicknesses of the set of samples; and
generate one or more measurements of the set of samples based on measurement data from the optical sub-system.

2. The measurement system of claim 1, wherein the set of samples all have a common thickness.

3. The measurement system of claim 1, wherein at least one sample in the set of samples has a thickness different than at least one additional sample in the set of samples.

4. The measurement system of claim 1, wherein the on-tool thickness measurements include multiple thickness measurements for at least one sample in the set of samples, wherein the one or more processors are further configured to execute program instructions causing the one or more processors to generate wafer bow data based on the on-tool thickness measurements.

5. The measurement system of claim 4, wherein the sample-specific hard stop positions provided to the focus adjustment system include site-specific hard stop positions based on the wafer bow data.

6. The measurement system of claim 1, wherein the one or more processors are further configured to execute program instructions causing the one or more processors to:
generate a score for each sample within the set of samples based on one or more sample characteristics, wherein the one or more sample characteristics include one or more corresponding on-tool thickness measurements; and
direct the optical sub-system to generate measurement data for samples in the set of samples having a score that satisfies a selected threshold and exclude remaining samples in the set of samples.

7. The measurement system of claim 6, wherein the one or more sample characteristics further comprise wobble measurements.

8. The measurement system of claim 7, wherein the on-tool thickness measurements include multiple thickness measurements for at least one sample in the set of samples, wherein the one or more processors are further configured to execute program instructions causing the one or more processors to generate wafer bow data based on the on-tool thickness measurements, wherein the one or more sample characteristics further comprises the wafer bow data.

9. The measurement system of claim 1, wherein the one or more processors are further configured to execute program instructions causing the one or more processors to generate an alert when a thickness of a sample in the set of samples differs from a corresponding on-tool thickness measurement from the sample measurement sub-system.

10. The measurement system of claim 1, wherein the optical sub-system comprises a metrology sub-system, wherein the one or more measurements of the set of samples comprises metrology data.

11. The measurement system of claim 10, wherein the optical sub-system comprises an image-based metrology sub-system, wherein the measurement data generated by the one or more detectors comprises image data.

12. The measurement system of claim 1, wherein the optical sub-system comprises an inspection sub-system, wherein the one or more measurements of the set of samples comprises inspection data.

13. The measurement system of claim 12, wherein the one or more processors are further configured to execute program instructions causing the one or more processors to at least one of characterize or identify one or more defects on the set of samples based on the inspection data.

14. A measurement system comprising:
an optical sub-system comprising:
an objective lens;
one or more detectors configured to generate measurement data based on light from a test sample collected by the objective lens; and
a focus adjustment system including one or more translation stages configured to control a separation distance between the objective lens and the test sample;
a sample management sub-system configured to receive a set of samples for measurement by the optical sub-system;
a sample measurement sub-system configured to measure a thickness of at least one sample from the set of samples prior to characterization by the optical sub-system; and
a controller including one or more processors configured to execute program instructions causing the one or more processors to:
receive one or more recipes including instructions for characterizing the set of samples with the optical sub-system, wherein the one or more recipes include thicknesses for the set of samples;
receive on-tool thickness measurements for the set of samples from a sample measurement sub-system configured to measure a thickness of at least one sample from the set of samples prior to characterization by the optical sub-system, wherein the at least one sample is from the sample measurement sub-system coupled to the optical sub-system;
validate the thicknesses of the set of samples provided by the one or more recipes with the on-tool thickness measurements;
provide the focus adjustment system with sample-specific hard stop positions based on the validated thicknesses of the set of samples; and
generate one or more measurements of the set of samples based on measurement data from the optical sub-system.

15. The measurement system of claim 14, wherein the set of samples all have a common thickness.

16. The measurement system of claim 14, wherein at least one sample in the set of samples has a thickness different than at least one additional sample in the set of samples.

17. The measurement system of claim 14, wherein the on-tool thickness measurements include multiple thickness measurements for at least one sample in the set of samples, wherein the one or more processors are further configured to execute program instructions causing the one or more processors to generate wafer bow data based on the on-tool thickness measurements.

18. The measurement system of claim 17, wherein the sample-specific hard stop positions provided to the focus adjustment system include site-specific hard stop positions based on the wafer bow data.

19. The measurement system of claim 14, wherein the one or more processors are further configured to execute program instructions causing the one or more processors to:
generate a score for each sample within the set of samples based on one or more sample characteristics, wherein the one or more sample characteristics include one or more corresponding on-tool thickness measurements; and
direct the optical sub-system to generate measurement data for samples in the set of samples having a score that satisfies a selected threshold and exclude remaining samples in the set of samples.

20. The measurement system of claim 19, wherein the one or more sample characteristics further comprise wobble measurements.

21. The measurement system of claim 20, wherein the on-tool thickness measurements include multiple thickness measurements for at least one sample in the set of samples, wherein the one or more processors are further configured to execute program instructions causing the one or more processors to generate wafer bow data based on the on-tool thickness measurements, wherein the one or more sample characteristics further comprises the wafer bow data.

22. The measurement system of claim 14, wherein the one or more processors are further configured to execute program instructions causing the one or more processors to generate an alert when a thickness of a sample in the set of samples differs from a corresponding on-tool thickness measurement from the sample measurement sub-system.

23. The measurement system of claim 14, wherein the optical sub-system comprises a metrology sub-system, wherein the one or more measurements of the set of samples comprises metrology data.

24. The measurement system of claim 23, wherein the optical sub-system comprises an image-based metrology sub-system, wherein the measurement data generated by the one or more detectors comprises image data.

25. The measurement system of claim 14, wherein the optical sub-system comprises an inspection sub-system, wherein the one or more measurements of the set of samples comprises inspection data.

26. The measurement system of claim 25, wherein the one or more processors are further configured to execute program instructions causing the one or more processors to at least one of characterize or identify one or more defects on the set of samples based on the inspection data.

27. A method comprising:
receiving one or more recipes including instructions for characterizing a set of samples with an optical sub-system, wherein the one or more recipes include thicknesses for the set of samples, wherein the optical sub-system comprises:
an objective lens;
one or more detectors configured to generate measurement data based on light from a test sample collected by the objective lens; and
a focus adjustment system including one or more translation stages configured to control a separation distance between the objective lens and the test sample;
receiving on-tool thickness measurements for the set of samples from a sample measurement sub-system;
validating the thicknesses of the set of samples provided by the one or more recipes with the on-tool thickness measurements generated by a sample measurement sub-system configured to measure a thickness of at least one sample from the set of samples prior to characterization by the optical sub-system;
providing the focus adjustment system with sample-specific hard stop positions based on the validated thicknesses of the set of samples; and
generating one or more measurements of the set of samples based on measurement data from the optical sub-system.

28. The method of claim 27, wherein the on-tool thickness measurements include multiple thickness measurements for at least one sample in the set of samples, wherein the method further comprises generating wafer bow data based on the on-tool thickness measurements.

29. The method of claim 28, wherein the sample-specific hard stop positions provided to the focus adjustment system include site-specific hard stop positions based on the wafer bow data.

30. The method of claim 27, further comprising:
generating a score for each sample within the set of samples based on one or more sample characteristics, wherein the one or more sample characteristics include one or more corresponding on-tool thickness measurements; and
directing the optical sub-system to generate measurement data for samples in the set of samples having a score that satisfies a selected threshold and exclude remaining samples in the set of samples.

31. The method of claim 30, wherein the one or more sample characteristics further comprise wobble measurements.

32. The method of claim 31, wherein the on-tool thickness measurements include multiple thickness measurements for at least one sample in the set of samples.

33. The method of claim 32, further comprising:
generating wafer bow data based on the on-tool thickness measurements, wherein the one or more sample characteristics further comprises the wafer bow data.
